(19) United States
(12) Patent Application Publication
(10) Pub. No.: US 2017/0346938 A1
(43) Pub. Date: Nov. 30, 2017

(54) Sent Text Correction Feature

(71) Applicant: International Business Machines Corporation, Armonk, NY (US)

(72) Inventors: John B. Allen, Austin, TX (US); Nathan D. Fontenot, Georgetown, TX (US); Christy L. Norman Perez, Austin, TX (US); Michael T. Strosaker, Austin, TX (US); George C. WIlson, Austin, TX (US)

(73) Assignee: International Business Machines Corporation, Armonk, NY (US)

(21) Appl. No.: 15/168,362

(22) Filed: May 31, 2016

(51) Int. Cl. H04M 1/725; H04L 12/58; H04W 4/12; H04W 4/18

(52) U.S. Cl. CPC H04M 1/72552; H04W 4/18; H04L 51/063; H04W 4/12

(57) ABSTRACT

Provided are techniques for a user interface (UI) enabling a user to identity and modify previously transmitted electronic message from a first device to a second device; and, responsive to a modification of the previously transmitted outgoing message from the first device, generating a modification message, transmitting the modification message to the second device and, responsive to receiving the modification message on the second device, correlating the modification message to a previously received incoming message on the second device and modifying the previously received incoming message in accordance with information transmitted in conjunction with the modification message to generate a modified message.

### FIELD OF DISCLOSURE

The claimed subject matter relates generally to electronic messaging and, more specifically, to providing technology to correct erroneous electronic messages.

### BACKGROUND OF THE INVENTION

More and more communication is becoming electronic. Electronic mail, or “email,” and electronic text messages, or “text messages,” are increasingly being relied upon rather than telephones and regular, or “snail,” mail. Of course, such messages may include more than simply text. For example a sender may attach images to an email or text message. One advantage of email and text messages is the speed at they can be delivered. Regardless of where in the world the sender and receiver may be located, such messages are routinely delivered almost instantaneously.

Currently, there are electronic messaging applications that that enable a sender to place a “hold” on such a message thereby enabling the sender to confirm that the message is correct before the message is sent, or transmitted. However, once a message has been successfully transmitted there are only limited options available to correct an error. Technology exists for retracting an email message that has not been read by a recipient by deleting the message from a corresponding server.

### SUMMARY

Provided are techniques to enable a sender of an electronic message, or “text message,” to modify, or “edit,” a text message after transmission. In one embodiment, this would result in the edited message being displayed rather than the original message. Another embodiment enables the history of a message to be preserved. For example, an edited message may be displayed in conjunction with an indicia, such as an asterisk or different color text, to indicate that the message has been altered. In this manner, a recipient may be provided the ability to view both the original and modified messages.

Provided are techniques for a user interface (UI) enabling a user to identify and modify previously transmitted electronic message from a first device to a second device; and, responsive to a modification of the previously transmitted outgoing message from the first device, generating a modification message, transmitting the modification message to the second device and, responsive to receiving the modification message on the second device, correlating the modification message to a previously received incoming message on the second device and modifying the previously received incoming message in accordance with information transmitted in conjunction with the modification message to generate a modified message.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures.

FIG. 1 is an electronic messaging architecture (EMA) that may support the claimed subject matter.

FIG. 2 is a block diagram of an electronic messaging correction module (EMCM) that may implement aspects of the claimed subject matter.

FIG. 3 is a flowchart of a Modify Message process that may implement aspects of the claimed subject matter.

FIG. 4 is a flowchart of a Receive Message process that may implement aspects of the claimed subject matter.

FIG. 5 is an illustration of a mobile telephone displaying messages that may be modified in accordance with the claimed subject matter.

FIG. 6 is an illustration of a mobile telephone displaying messages that have been modified in accordance with the claimed subject matter.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

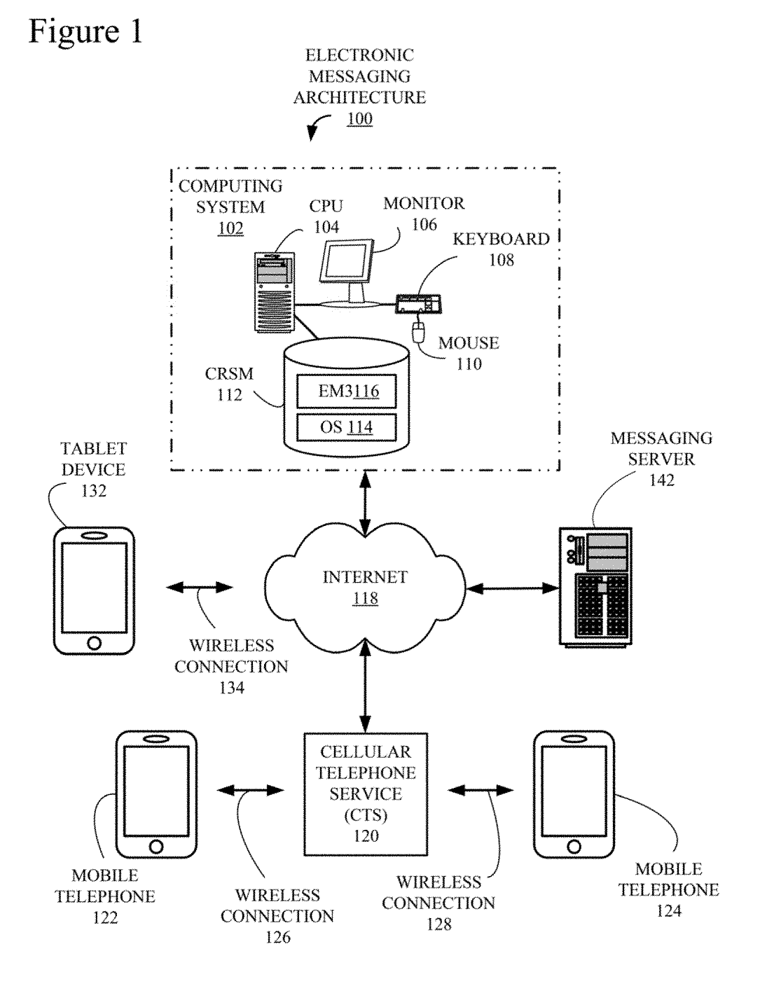

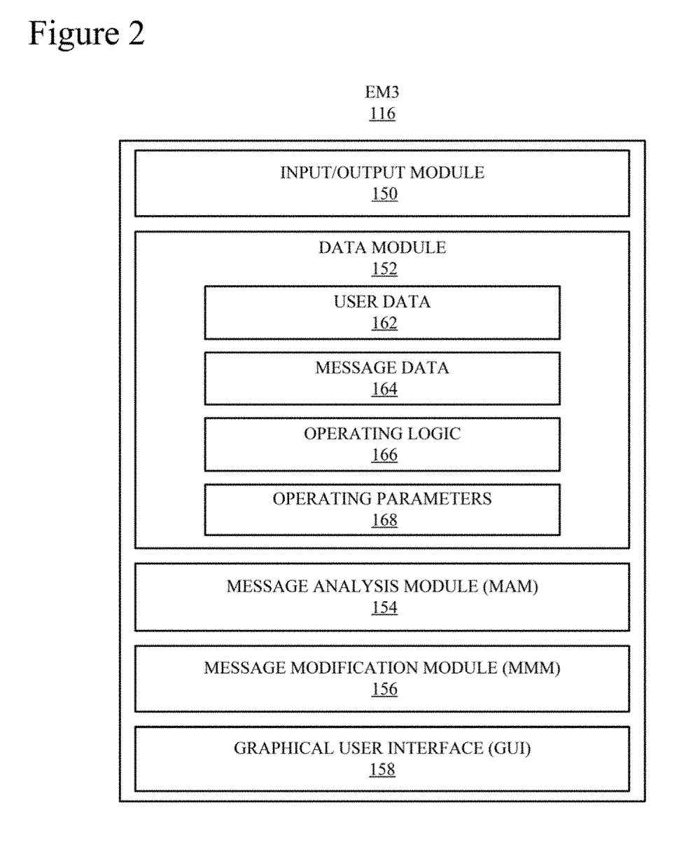

Turning now to the figures, FIG. 1 is an electronic messaging architecture (EMA) 100 that may support the claimed subject matter. A computing system 102 includes a central processing unit (CPU) 104, coupled to a monitor, or “display,” 106, a keyboard 108 and a pointing device, or “mouse,” 110, which together facilitate human interaction with computing system 102 and other elements of EMA 100. Also included in computing system 102 and attached to CPU 104 is a computer-readable storage medium (CRSM) 112, which may either be incorporated into computing system 102 i.e. an internal device, or attached externally to CPU 104 by means of various, commonly available connection devices such as but not limited to, a universal serial bus (USB) port (not shown). CRSM 112 is illustrated storing logic associated with an operating system 114 and an Electronic Messaging Modification Module (EM3) 116 that, in the following examples, incorporates the claimed subject matter. It should be noted that a typical computing system would include more than merely an OS and EM3 116, but for the sake of simplicity only the two components are illustrated. EM3 116 represents an electronic messaging correction and modification system that provides novel flexibility for users of electronic messaging. EM3 116 is described in more detail below in conjunction with FIGS. 2-6.

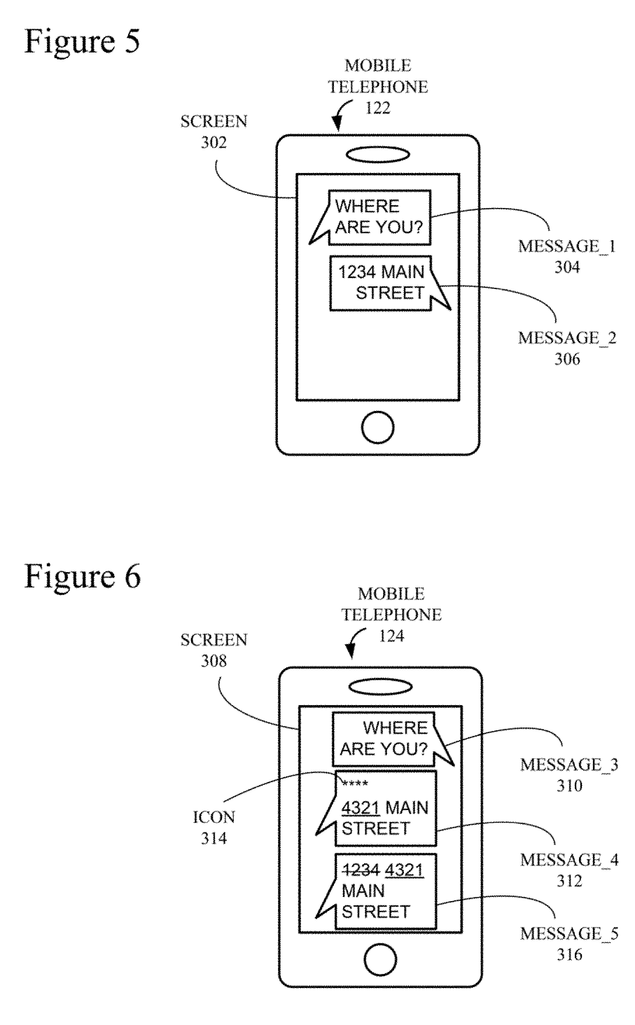

In EMA 100, computing system 102 and CPU 104 are connected to the Internet 118, which is also connected to Cellular Telephone Service (CTS) 120. In this example, CTS 120 is providing cellular service to two (2) mobile devices, i.e., a mobile telephone 122 and a mobile telephone 124. It will be understood by those with knowledge in the relevant arts that mobile telephones are also typically computing devices and, as such, would also each include a CPU, display and CRSM, which are not shown. Rather than a keyboard and mouse, mobile telephones 122 and 124 may include touch screens 302 and 308, respectively (see FIGS. 5 and 6). It should be known by those with experience with mobile device that, in addition to a touch on a touch screen, such devices may be responsive to user actions such as, but not limited to, gestures and voice commands. Mobile telephones 122 and 124 are communicatively coupled to CTS 120 via wireless connections 126 and 128, respectively.

Also coupled to Internet 118 are a tablet device 132, via a wireless connection 134, and a messaging server, or simply “server,” 142. Like mobile telephones 122 and 124, tablet device 132 would have a CPU, display, CRSM and touch screen, none of which are shown. Although not shown, like computer system 102, server 142 would typically include a CPU, monitor, keyboard, mouse and CRSM.

Mobile telephones 122 and 124 and tablet device 132 are examples of devices, in addition to computing system 102, that may implement the claimed subject matter by incorporating logic associated with a EM3 such as EM3 116. Messaging server 142 may also incorporate aspects of the claimed subject matter. In the following description, the claimed subject matter is described with respect to electronic messages transmitted between users on computing systems 102 and mobile telephone 122 and between mobile telephones 122 and 124. The disclosed technology is equally applicable to other types of electronic messaging such as emails. In some of the following examples, the disclosed technology is implemented by EM3 116 and corresponding EM3s (not shown) on mobile telephones 122 and 124. It should be understood intermediate computing systems such as server 142 would also typically be involved in the implementation of a EMA like EMA 110 in general and in the implementation of the claimed subject matter.

Although in this example, computing system 102, mobile telephones 122 and 124, tablet device 132 and server 142 are communicatively coupled via some combination of Internet 118 and CTS 120, they could also be coupled through any number of communication mediums such as, but not limited to, a local area network (LAN) (not shown), a wide area network (WAN) and a plain ole telephone system (POTS) (not shown). Wireless connections such as 126, 128 and 134 may be cellular, WiFi, Bluetooth or any currently available or yet to be developed medium. Further, it should be noted there are many possible electronic messaging configurations, of which computing EMA 100 is only one simple example.

FIG. 2 is a block diagram of EM3 116, first introduced above in conjunction with FIG. 1, in greater detail. EM3 116 includes an input/output (I/O) module 150, a data module 152, a message analysis module (MAM) 154, a message modification module (MMM) 156 and a graphical user interface (GUI) 158. For the sake of the following examples, EM3 116 is assumed to be associated with logic stored on CRSM 112 (FIG. 1) and to execute on one or more processors (not shown) of CPU 104 (FIG. 1) of computing system 102 (FIG. 1). It should be understood that the claimed subject matter can be implemented in many types of computing systems and data storage structures but, for the sake of simplicity, is described only in terms of computing system 102 and EMA 100 (FIG. 1). It should be understood that other devices of EMA 100, such as mobile telephones 122 and 124 (FIG. 1) and tablet device 132 (FIG. 1), also incorporate an EM3 like EM3 116. Throughout the Specification, the described components of EM3 116 are employed as a reference to the components of similar EM3s on the other devices. Further, the representation of EM3 116 in FIG. 2 is a logical model. In other words, components 150, 152, 154, 156 and 158 may be stored in the same or separates files and loaded and/or executed within EMA 100 or their respective devices either as a single system or as separate processes interacting via any available inter process communication (IPC) techniques.

I/O module 150 handles any communication EM3 116 has with other components of EMA 100. Data module 152 is a data repository for information that EM3 116 requires during normal operation. Examples of the types of information stored in data Module 152 include user data 162, message data 164, operating logic 166 and operating parameters 168. User data 150 stores the identity and relevant information of specific users that utilize the service provided by the claimed subject matter. Message Data 164 stores information on currently active message threads that may be the subject of modification in accordance with the claimed subject matter. Operating logic 166, in addition to MAM 154, MMM 156 and GUI 158, stores program code to implement functionality of EM3 116. Operating parameters 168 includes information on various user preferences that have been set. For example, a user may specify particular display options for modified messages, as described in more detail below.

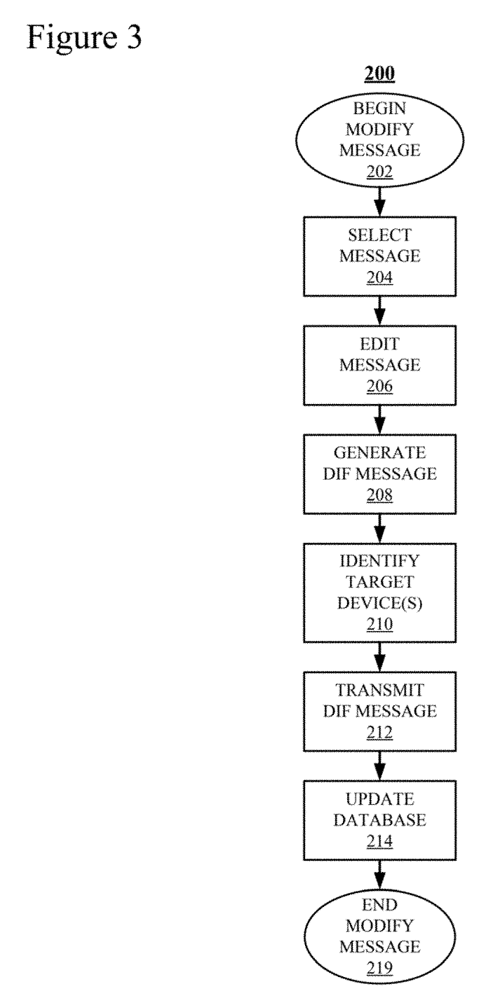

MAM 154 analyses both incoming and outgoing messages to determine if processing in accordance with the claimed subject matter is necessary. If so, MAM 154 correlates a message to a particular message stream or streams. If not, typical message processing is allowed to proceed. Once MAM 154 has determined that a particular incoming or outgoing message has been marked for processing, MMM 156 performs that processing. For outgoing messages, that may include a determination of specific modifications to a correlated message, including the generation of a file indicating the differences between the original message and the modification, or a “dif” file. With respect to incoming messages, such processing may include a implementation of the modification with respect to the correlated message. GUI component 158 enables users of EM3 116 to interact with and to define the desired functionality of EM3 116, typically by the setting of parameters in operating parameters 168. Components 150, 152, 154, 156, 158, 162, 164, 166 and 168 are described in more detail below in conjunction with FIGS. 3-6.

FIG. 3 is a flowchart of a Modify Message process 200 that may implement aspects of the claimed subject matter. In this example, logic associated with process 200 is stored on a CRSM (not shown) of mobile telephone 122 (FIG. 1) and execute on a processor (not shown) of mobile telephone 122. For the sake of convenience, process 200 is described with respect to EM3 116 (FIGS. 1 and 2) which would be similar to an EM3 (not shown) installed on mobile telephone 122.

Process 200 starts in a “Begin Modify Message” block 202 and proceeds immediately to a “Select Message” block 204. During processing associated with block 204, the user, using a user interface on mobile telephone 122, selects a previously transmitted message to be modified (see FIG. 5). Such a selection may be implemented as simply as having the user find the message and press the message on a touch screen (see 302, FIG. 5) to activate an editing GUI (not shown). Once a message has been selected, the user employs the GUI to modify the selected message during processing associated with an “Edit Message” block 206.

During processing associated with a “Generate Dif Message” block 208, MAM 154 (FIG. 2) of EM3 116 compares the modified message to the originally transmitted message and generates a file that details the differences between the two, i.e. a “dif” file. The dif file also includes metadata to indicate that that the corresponding message is an update to a previously transmitted message and information to correlate the correction message to a previously transmitted message. An example of a sent message is as follows:

{“message_id”: 123,
“date”: 20160603,
“message_body”: I am at 1234 Main Street”
}

If the sender then realizes the correct address is “4321” Main Street,” a correction or dif message may be sent as follows:

{“message_id”: 123,
“date”: 20160603,
“message_body”: −“1234”
+”4321”
}

It should be understood that this is merely one simple example and that more sophisticated schemes may be employed. For example, in an alternative embodiment, the entire edited message may be transmitted in conjunction with metadata indicating that the message is a correction or modification of a previously transmitted message. In that scenario, the original message may either be simply replaced or a dif file generated at the recipient's device.

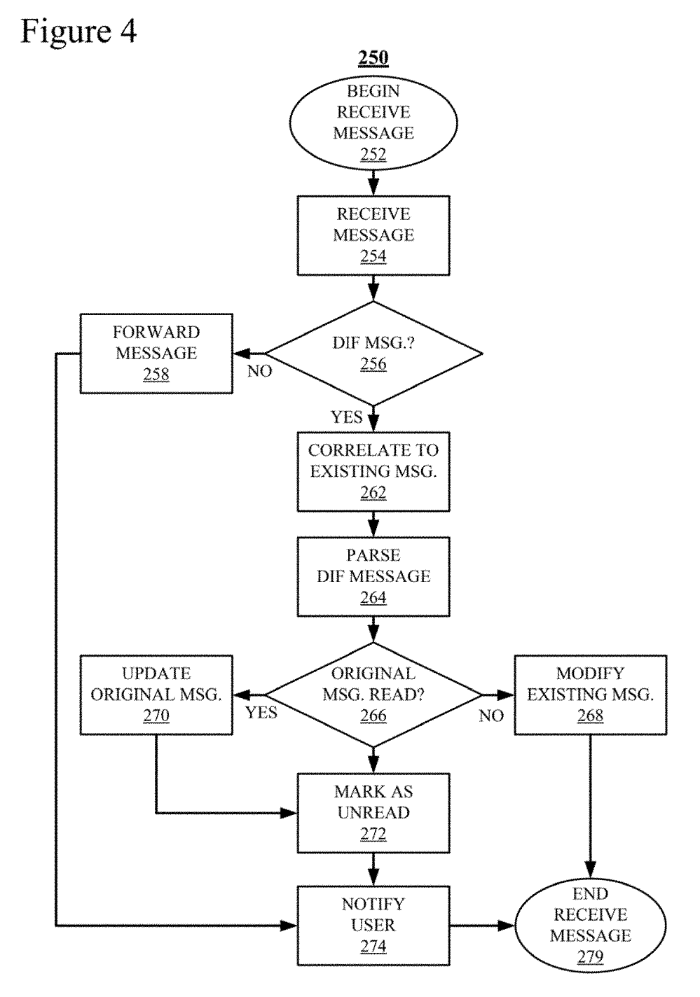

During processing associated with an “Identify Target Device(s)” block 210, MAM 154 also determines the one of more recipients of the original message to whom the original message was transmitted. For the sake of the following examples, a messages to a user on mobile telephone 124 is assumed. During processing associated with a “Transmit Dif Message” block 212, the dif file generated during processing associated with block 208 is transmitted to the users/devices determined during processing associated with block 210. Typically, the dif message may be transmitted by pressing a Send button (not shown) the mobile telephone. The processing of the dif file on the target device is described below in conjunction with FIG. 4.

During processing associated with an “Update database” block 214, the internal state of the electronic messaging system is modified to reflect the modifications and transmittals described above. Finally, during processing associated with an “End Modify Message” block 219, process 200 is complete.

FIG. 4 is a flowchart of a Receive Message process 250 that may implement aspects of the claimed subject matter. In this example, logic associated with process 250 is stored on a CRSM (not shown) of mobile telephone 124 (FIG. 1) and execute on a processor (not shown) of mobile telephone 124. Like the description of process 200, the components of EM3 116 (FIGS. 1 and 2) are used to describe a similar EM3 (not shown) installed on mobile telephone 124.

Process 250 starts in a “Begin Receive Message” block 252 and proceeds immediately to a “Receive Message” block 254. During processing associated with block 254 a message transmitted from, in this example, mobile telephone 122 (FIG. 1) (see 212, FIG. 3) is received on mobile telephone 124. During processing associated with a “Dif Message?” block 256, a determination is made as to whether or not the electronic message received during processing associated with block 254 is a standard message or a dif file generated in accordance with the claimed subject matter. In other words, process 250 is responsible for processing both typical, unmodified messages and messages that represent requested modifications to previously transmitted messages. Such a determination may be made simply by examining a message ID. In that case, a new ID indicates a new message and a message ID that corresponds to a previously received message indicates that the message includes a dif file. If a determination is made the message received is a typical message, control proceeds to a “Forward Message” block 258 during which the incoming message is processed in accordance with the typical procedures for handling messages, typically by placing the message on the user's message queue and notifying the user of the message's arrival.

If, during processing associated with block 256, a determination is made that the message received during processing associated with block 254 is a dif file, control proceeds to a “Correlate to Existing Message (Msg.)” block 262. During processing associated with block 262, MAM 154 determines the original message stream and message with which the dif message is associated. During processing associated with a “Parse Dif Message” block 262, MAM 154 analyses the message receive during processing associated with block 154 to identify the differences that the user who transmitted the file would like to have implemented, i.e., the edited differences between the originally transmitted file and the modification and/or corrections. (see 206, FIG. 3).

During processing associated with an “Original Msg. Read?” block 266, a determination is made as to whether or not the original message has already been read. If so, control proceeds to an “Modify Original Msg.” block 270. During processing associated with block 270, the original message is changed to reflect the editing specified in the dif file received during processing associated with block 254. It should be noted that if the original message has not been read the original user notification that a message has been received is typically sufficient and a new notification is not necessary.

If, during processing associated with block 266 a determination is made that the original message has already been read, control proceeds to an “Update Original Msg.” block 270. During processing associated with block 270, the original message is modified in accordance with the dif file received during processing associated with block 254. In addition, an icon (see 314, FIG. 6). is placed in the message to indicate to the recipient of the message that the message has been modified. In the alternative the message may have indications of the changes made, such as strikethroughs and underlining (see 316, FIG. 6). Control then proceeds to a “Mark as Unread” block 272, ensuring which the modified message is marked as unread. In response to the forwarding of a typical message during processing associated with block 258 or the marking of a modified message during processing associated with block 272, control proceeds to a “Notify User” block 274, the recipient user is notified that a message requires attention. Such notification may be a user's standard notification that a new message has arrived, i.e. the same as the notification transmitted when a standard message arrives and is forwarded during processing associated with block 258. In the alternative, a different notification may be employed to indicate that the updated message has a different priority than a standard message. The specific notifications and even whether or not to transmit a notification may be specified by setting a parameter in operating parameters 168 (FIG. 2).

Finally, once the user has been notified during processing associated with block 274 or a original but unread message has been processed during processing associated with block 268, control proceeds to an “End Receive Message” block 279 in which process 250 is complete.

FIG. 5 is an illustration of mobile telephone 122 (FIG. 1) displaying messages that may be modified in accordance with the claimed subject matter. In this example, mobile telephone 122 is a device that corresponds to the sender who wishes to correct or modify a previously sent message. Those with experience with mobile telephones should be familiar with touch screens such as a screen 302 as well as the typical mechanics of sending and receiving electronic messages. The sender has received a message_1 304 from, in the following examples, a user on mobile telephone 124 (FIG. 1; see FIG. 6). The message is a question, “Where are you?” The user of mobile telephone 122 replies in a message_2 306 with the text, “1234 Main Street.” If the user of mobile telephone 122 realizes that an incorrect address has been sent, a GUI (not shown) enables the user to modify the message (see 312 and 316, FIG. 6) and transmit a dif file (see 212, FIG. 4).

FIG. 6 is an illustration of mobile telephone 124 (FIG. 1) displaying messages that have been modified in accordance with the claimed subject matter. First, the user of mobile telephone 124 transmits a message_3 310, “Where are you?” (see 304, FIG. 5) to the user of mobile telephone 122 (FIGS. 1 and 5), which is received by the user of mobile telephone 122 as message_1 304 (FIG. 5). As explained above in conjunction with FIG. 5, the user of mobile telephone 122 responds with message_2 306, “1234 Main Street” but realizes that an incorrect address has been sent and transmits a correction. In this example, the user of mobile telephone has not yet read message_2 306 so the MAM 154 (FIG. 2) modifies the original message and displays the corrected message as message_4 312, Message_4 312 has the correct address, “4321 Main Street” and also includes an icon 314, which in this example is merely “****,” indicating that the original message_2 306 has been modified. The messaging UI also provides means for the user to view the original message, which in this example is displayed as message_5 316. Message_5 316 shows the erroneous address number “1234” with strike through and the corrected address number, “4321,” underlined. Such means may include, but are not limited to, a touch on the icon or designated potion of the screen, a voice command and a gesture.

It should be understood that the disclosed technology may be integrated with existing text messaging application and infrastructure, i.e., making user use of network's existing text messaging protocols. Therefore, additional metadata may not need to be added to already-standardized protocols. The claimed subject matter is also designed so that users of older devices that do not include support for editing text messages can still receive updates in a readable format. The text message character set, GSM 03.38 (aka 3GPP 23.038), includes an escape character that renders as a space. (There are other characters that may be used for this purpose; the escape character is used for illustrative purposes.) The same UI elements as the first example are employed. If the user modifies:
“I'll meet you at the restaurant at 2 PM.” to
“I'll meet you at the restaurant at 3 PM.,”
   The following message would be sent from the initiator's device to the recipient(s)'. (In the following line, the unprintable escape character is shown as a %):
% UPDATE:%“at 3 PM”,% not %“at 2 PM”%
   An edit-aware text message app would easily be able to identify that this is an update to the prior message in the thread, and would use common diff techniques to update “at 3 PM” to “at 2 PM”. (Again, the receiver would only be notified of the update to the original message if she had already read the original message.) The real advantage of this format is that a user of a messaging device that does not allow for updating old message would receive the update as a normal text message (including the normal “new message” notification) that would look like the following:
UPDATE: “at 3 PM”, not “at 2 PM.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A method for the modification of delivered electronic messages, comprising:
providing a user interface (UI) enabling a user to identify and modify previously transmitted electronic message from a first device to a second device;
responsive to a modification of the previously transmitted outgoing message from the first device:
generating a modification message; and
transmitting the modification message to the second device; and
responsive to receiving the modification message on the second device:
correlating the modification message to a previously received incoming message on the second device;
modifying the previously received incoming message in accordance with information transmitted in conjunction with the modification message to generate a modified message;
displaying the modified message on the second device; and
in response to detecting that the previously transmitted message has been read by the user on the second device, displaying, on the second device, marking the previously transmitted message as unread.

2. The method of claim 1, wherein the electronic message is a text message.

3. The method of claim 1, wherein the electronic message is an electronic mail message (email).

4. The method of claim 1, further comprising, in response to detecting that the previously transmitted message has already been accessed by the user on the second device, displaying, on the second device, an indication in conjunction with the modified message that the message is a modification of the previously transmitted message.

5. The method of claim 4, further comprising, displaying on the second device the unmodified, previously transmitted message in response to an action by the user on the second device.

6. The method of claim 1, wherein the first and second devices are from a group of devices consisting of:
mobile telephones;
tablet computing devices; and
personal computers.

7. The method of claim 1, wherein the UI is responsive to a group of actions consisting of:
a gesture;
a voice command; and
a touch on a touch screen.

8. An apparatus for the modification of delivered electronic messages, comprising:
a processor,
a computer-readable storage medium couple to the processor; and
instructions stored on the computer-readable storage medium and executed on the processor for performing a method, the method comprising:
providing a user interface (UI) enabling a user to identify and modify previously transmitted electronic message from a first device to a second device; and
responsive to a modification of the previously transmitted outgoing message from the first device:
generating a modification message; and
transmitting the modification message to the second device;
such that, on the second device, responsive to receiving the modification message, the second device performs a method comprising:
correlating the modification message to a previously received incoming message;
modifying the previously received incoming message in accordance with information transmitted in conjunction with the modification message to generate a modified message;
displaying the modified message on the second device; and
in response to detecting that the previously transmitted message has been read by the user on the second device, displaying, on the second device, marking the previously transmitted message as unread.

9. The apparatus of claim 8, wherein the electronic message is a text message.

10. The apparatus of claim 8, wherein the electronic message is an electronic mail message (email).

11. The apparatus of claim 8, the method performed on the second device further comprising, in response to detecting that the previously transmitted message has already been accessed by the user on the second device, displaying an indication in conjunction with the modified message that the message is a modification of the previously transmitted message.

12. The apparatus of claim 11, the method performed on the second device further comprising, displaying the unmodified, previously transmitted message in response to an action by the user on the second device.

13. The apparatus of claim 8, wherein the first and second devices are from a group of devices consisting of:
mobile telephones;
tablet computing devices; and
personal computers.

14. The apparatus of claim 8, wherein the UI is responsive to a group of actions consisting of:
a gesture;
a voice command; and
a touch on a touch screen.

15. A computer programming product for the modification of delivered electronic messages, comprising:
a non-transitory computer-readable storage medium; and
instructions stored on the computer-readable storage medium for execution on a processor for performing a method, the method comprising:
providing a user interface (UI) enabling a user to identify and modify previously transmitted electronic message from a first device to a second device; and
responsive to a modification of the previously transmitted outgoing message from the first device:
generating a modification message; and
transmitting the modification message to the second device;
such that, on the second device, responsive to receiving the modification message, the second device performs a method comprising:
correlating the modification message to a previously received incoming message;
modifying the previously received incoming message in accordance with information transmitted in conjunction with the modification message to generate a modified message; and
displaying the modified message;
displaying the modified message on the second device; and
in response to detecting that the previously transmitted message has been read by the user on the second device, displaying, on the second device, marking the previously transmitted message as unread.

16. The computer programming product of claim 15, wherein the electronic message is a text message.

17. The computer programming product of claim 15, wherein the electronic message is an electronic mail message (email).

18. The computer programming product of claim 15, the method performed on the second device further comprising, in response to detecting that the previously transmitted message has already been accessed by the user on the second device, displaying an indication in conjunction with the modified message that the message is a modification of the previously transmitted message.

19. The computer programming product of claim 18, the method performed on the second device further comprising, displaying the unmodified, previously transmitted message in response to an action by the user on the second device.

20. The computer programming product of claim 15, wherein the UI is responsive to a group of actions consisting of:
a gesture;
a voice command; and
a touch on a touch screen.
